(19) United States
(12) Patent Application Publication
(10) Pub. No.: US 2010/0136403 A1
(43) Pub. Date: Jun. 3, 2010

(54) ELECTRIC FACILITY OPERATING ACCORDING TO GALVANIC PRINCIPLES

(75) Inventors: Tim Schafer, Niedersachswerfen (DE); Claudia Brasse, Hanau (DE); Andreas Gutsch, Ludinghausen (DE)

Correspondence Address: CHOATE, HALL & STEWART LLP, TWO INTERNATIONAL PLACE, BOSTON, MA, 02110, US

(73) Assignee: Li-Tech Battery GmbH, Kamenz (DE)

(21) Appl. No.: 12/499,191

(22) Filed: Jul. 8, 2009

(30) Foreign Application Priority Data
Jul. 9, 2008 (DE) 10 2008 032 263.6

(51) Int. Cl. H01M 10/50

(52) U.S. Cl. 429/120

(57) ABSTRACT

The invention relates to a facility (10, 20) operating according to galvanic principles such as particularly a battery, respectively an accumulator, in particular a lithium-ion battery, and assemblies thereof. The facility comprises a housing (12), at least one first current conductor (14), which protrudes from the housing (12), and at least one first heat conducting facility (24), which is connected to the first current conductor (14) in heat flow communication, and which is developed such to conduct thermal energy from the first current conductor (14).

A first facility (110) and a second facility (120) are arranged in a flat basis module such that a first housing (112) of the first facility (110) shares a plane with a second housing (113) of the second facility (120), and that the housing surface of the first housing from which the second current conductor protrudes faces the housing surface of the second facility from which the first current conductor of the second facility protrudes, wherein the second current conductor (116) of the first facility (110) may be connected in electric contact to the first current conductor (115) of the second facility. A heat conducting facility (124) is connected in heat flow communication to the second current conductor (116) of the first facility (110), or with the first current conductor (115) of the second facility (120) for conducting thermal energy.

Several facilities and/or flat basis modules may be spatially compactedly assembled in stacks in electric serial connection or parallel connection, respectively parallel stacks, wherein heat by means of heat conducting facilities may be dissipated from the current conductors.

The present invention relates to a facility operating according to galvanic principles such as a battery or an accumulator, particularly a lithium-ion battery.

A high-energy storage density characterizes batteries or accumulators, particularly lithium-ion batteries having been developed in the recent years. On the one hand, this allows the provision of high charge capacities or current capacities, on the other hand results in a heating of the battery, respectively the accumulator, during the charging operation, respectively discharging operation, during charging, respectively discharging of the battery, respectively the accumulator. Excessive heating results in a decrease of the capacity of the battery, respectively the accumulator, deterioration of the rechargeability, and decrease of the number of possible discharging and recharging cycles, in other words, results in the decrease of the durability of the battery, respectively the accumulator. In particular for lithium-ion-batteries, the person skilled in the art is familiar with the problem of the “thermal runaway”, in which from a certain threshold temperature, respectively a certain heat generation, the increase of the temperature intensifies itself and which, if this process is not reduced, results in a self-destruction of the lithium-ion battery. The problems associated with the heating appear in an intensified manner in facilities having a high-energy storage density and high capacity such as also in stacked assemblies of batteries, respectively accumulators, in which the heat dissipation via the housing walls of the facilities is limited.

The present invention is based on the problem to reduce the heating of facilities operating according to galvanic principles.

This problem is solved by a facility operating according to galvanic principles such as, in particular, a battery, respectively an accumulator, particularly a lithium-ion battery, comprising a housing and at least one first current conductor protruding from the housing, and which is characterized in that it comprises at least one first heat conducting facility that is connected to the first current conductor in heat flow communication, and that is developed such to allow for conducting thermal energy from the first current conductor. By means of the thermal flow communication with the first current conductor, which in turn is electrically connected to the electrodes that are arranged within the housing of the device, heat is conducted from the interior of the facility via the first current conductor and the first heat conducting facility, additionally to the heat conduction from the interior, by means of heat conduction and deflection via the housing surfaces, respectively the housing walls.

The term battery as used herein defines a container that consists of one or several internal cells, respectively electric storage cells, in which chemical energy is transferred to electricity, respectively electric energy, and which is used as a source of electric power.

The term accumulator as used herein defines a rechargeable cell, respectively an electric storage cell or battery, which is used as a source of electric power.

The term current conductor as used herein defines a device that conducts an electric current, which, at an electrode such as the cathode and the anode, conducts the electric charge, respectively current that is generated within an electric storage cell, from the electrode beyond the cell, as the case may be by feeding said electric charge, respectively current, through the housing wall of the cell. For example, the device-conducting current may be a line wire or a line plate that is produced, in particular, from a metal or a metal alloy. Within the cell, an internal end of the current conductor may be connected to the electrode in an electrically conducting manner. Beyond the cell, another end of the electrically conducting device may be connected in an electrically conducting manner to a connection for collecting, respectively providing the current, and for connecting to a connection assembly or clamp connection, or may be directly developed as a connection as such.

The term heat flow communication as used herein defines a connection, respectively a coupling of two elements such as a heat conducting facility comprising a current conductor that is developed such to effectively transfer a heat flow from the one to the other element, i.e. having good heat conduction and low resistance for the heat flow. The heat flow communication may be provided by means of a close, preferably laminar, particularly positive and/or non-positive connection between surfaces of the coupled elements. Between the elements, also a thermally conductive foil and/or layer may be provided that is developed such, in particularly soft and/or flexible, to balance any unevenness of contacted surfaces of the coupled elements, and to intensify the contact between the contacted surfaces.

The term heat conducting facility as used herein defines a device that is made of a heat conducting material for conducting, respectively dissipating thermal energy (heat energy) from a first location where, for example, a heating is reduced, or a cooling is effected, e.g. cooling of an article, to a second different location, where the heat energy may dissipate, e.g. may be converted to another energy form, or may be dissipated, in particular e.g. a heat sink, such as a heating or cooling reservoir, such as a liquid bath, such as a cooling water reservoir, or a stream of cooling water, respectively a temperature reservoir, in particular one with temperature control. The contact, respectively the connections of the heat conducting facility to the first location, such as an article to be cooled, and the contact, respectively the connection to the heat sink, should be developed in a well heat conducting manner.

Preferably, the facility comprises at least one second current conductor protruding from the housing, and at least a second heat conducting facility being in heat flow communication with the second current conductor, and that is developed such to be suitable to conduct thermal energy from the second current conductor. By means of the second heat conducting facility, via the second current conductor, a still better, respectively more efficient heat conduction can be achieved from the interior of the housing of the facility via both current conductors, and thus from both electrodes being arranged in the interior of the housing, and being connected to said current conductors.

Preferably, the first current conductor protrudes from the first housing surface of the housing, and the second current conductor protrudes from a second housing surface of the housing, wherein the second housing surface is opposed to the first housing surface. This arrangement, respectively geometry, allows for a direct arrangement in series of the facility, in particular a serial connection of facilities, wherein for adjoining facilities, respectively, a second current conductor of the one first facility is connected to the first current conductor of an adjoining second facility via a short electric connection, respectively preferably also via a direct electrically conducting contact of the first with the second current conductor.

Preferably, for the first heat conducting facility, respectively the second heat conducting facility, the heat flow communication is effected by connecting said facilities in a positive and/or non-positive manner to the first, respectively second current conductor, respectively. The positive and/or non-positive connection between the heat conducting facility and the current conductor decreases the losses of heat transportation, in other words improves the heat transfer from the current conductor to the heat conducting facility.

In the connection of a heat conducting facility to a current conductor for the generation of the heat flow communication, it is ensured that the connection is electrically isolating such to conduct heat energy, respectively heat flow, however essentially no current, from the current conductor via the heat conducting facility. For this purpose, an electrically isolating layer, respectively foil, may be provided between the heat conducting facility and the current conductor

Preferably, at least the portion of the first current conductor protruding from the housing has an elongated form. In the heat flow communication, the elongated form allows for a large transfer area, and thus a good heat transfer, respectively a low heat transport resistance.

Furthermore, preferably, the portion of the current conductor protruding from the housing, is in thermal heat flow communication along the long dimension of the current conductor with the electrode of the facility, which is in electric connection to the current conductor. Thereby, also a good heat flow, respectively a low heat flow resistance, is possible with respect to the heat transfer from the interior of the facility from the electrode via the current conductor and the heat conducting facility to the external connection.

The housing of the facility may be cylindrical ranging from an elongated cylindrical form, such as a rod-like form, up to the form of a disc, such as in particular a thin disc. Thereby, on the one hand, the facility may have the form of known cylindrical rechargeable accumulators as well as the form of a disc of so-called button cells.

Alternatively, the housing may also have a cuboid-shaped form, in particular a cuboid having a low height. Then, the facility has a plate-like form.

The embodiments having a cylindrical or cuboid-shaped housing having a low overall height up to a very low overall height allows for a compact mounting of the facility operating according to galvanic principles into a device to be supplied with electricity, in particular e.g. close, respectively parallel, to an outer housing wall of the device to be supplied with electricity.

Preferably, the housing essentially has a cuboid-shaped form, and the portion of the first current conductor protruding from the housing extends in parallel to the longest edge of the housing to a first housing surface being defined by the longest edge and a shortest edge of the first housing surface bordering the housing, and one portion of the second current conductor protruding from the housing extends to a second housing surface opposing the first housing surface. Thus, on the one hand, the longest possible area, respectively the passage area for the heat flow between the current conductor and the heat conducting facility to be mounted onto said current conductor, and on the other hand, also the greatest possible contact area for the heat flow communication between the current conductor and the electrode being arranged within the interior of the housing and being connected to said current conductor, allow for an optimal heat transfer from the interior of the housing to the heat conducting facility.

The first current conductor may be connected to a cathode of the facility, and the second current conductor may be connected to an anode of the facility. Thus, the current conductor, additionally to the conductance of electricity, also fulfils another object of the heat conductance from the interior of the housing. The first current conductor may form a negative terminal of the facility, and the second current conductor may form a positive terminal of the facility.

The housing essentially may have a cuboid-shaped form having two largest housing surfaces opposing each other, which are then termed as upper and lower housing surface, and two second largest housing surfaces opposing each other, and which are then termed as first and second lateral surfaces, and which share one edge from the group of the longest edges of the housing with the upper and the lower housing surface, respectively. Preferably, thereby, the distance between the upper and the lower housing surface is not greater than 30%, further preferred not greater than 20% and still further preferred not greater than 10% of the length of one of the longest edges. In this manner, the facility has a flat design, which allows for a compact mounting within a device to be supplied with current, for example parallel to a housing wall of the device. Furthermore, such a flat cuboid-shaped construction of the facility allows for a good stackability for several facilities, which are arranged side by side, in front of each other, and/or one upon the other.

Preferably, in this construction, the first current conductor protrudes from one of the two lateral surfaces, and the second current conductor protrudes from one of the other two lateral surfaces of the housing opposing the first lateral surface, and extends in parallel to one of the longest edges of the housing. Thus, an optimal heat transfer and current transfer from the electrodes via the first respectively second current conductor to the heat transfer facilities are achieved that are in heat flow communication with the current conductors.

Alternatively to this, the housing may further have two smallest housing surfaces being opposed to each other, which are then termed as first and second end surfaces, and the first current conductor may protrude from one of the two end surfaces, and the second current conductor may protrude from the other one of the two end surfaces. Such a construction of the facility allows for a compact stackability of facilities one upon the other, and side by side, wherein the electric connection of the current conductors and the access to the heat conducting facilities being in heat flow communication with the current conductors, may be provided at the end surfaces of the facility.

Preferably, the first heat conducting facility has an elongated form having a longitudinal direction, wherein it essentially completely covers the first current conductor, and protrudes in the longitudinal direction at least in one direction over the extension of the current conductor in its longitudinal direction. Thus, a good heat transfer, respectively heat flow communication, via a large passage area is possible.

At least two or more of such facilities may be electrically connected to each other for the increase of a total capacity, and may be mechanically compactedly arranged towards each other in proximity. In this respect, further aspects of the invention relate to the following.

In another aspect of the invention, a flat basis module of a device operating according to galvanic principles is provided. The flat basis module comprises a first facility operating according to galvanic principles comprising a first housing having an essentially cuboid-shaped form, a first current conductor protruding from a first lateral surface or first end surface, and a second current conductor protruding from a second lateral surface or second end surface of the housing opposing the first lateral surface or first end surface, as well as a second facility operating according to galvanic principles comprising a second housing having an essentially cuboid-shaped form, a first current conductor protruding from a first lateral surface or first end surface of the housing, and a second current conductor protruding from a second lateral surface or end surface of the housing opposing the first lateral surface or end surface. The first and second facilities are arranged such that the housing of the first device shares a plane with the housing of the second facility such that the housing surface of the first facility from which the second current conductor of the first facility protrudes faces the housing surface of the second facility from which the first current conductor of the second facility protrudes. Thus, the second current conductor of the first facility may be connected to the first current conductor of the second facility in a short path, preferably in electric contact. According to the invention, the flat basis module comprises also a heat conducting facility, which is connected in heat flow communication to the second current conductor of the first facility, or to the first current conductor of the second facility for conducting thermal energy. The assembly of the flat basis module of the first and second facility provides a duplication of capacity. By means of the assembly of both housings in a shared plane, a flat construction of the flat basis module and therefore a compact mounting into a device to be supplied with electricity via the flat basis module as well as a good stackability of two or several flat basis modules to a stack of two or more flat basis modules is possible.

Preferably, the second facility is essentially identical in construction to the first facility. Such a modular assembly allows for extensions to devices having a greater capacity, which is also supported by the flat construction and the stackability of the flat basis module.

Preferably, the second current conductor of the first facility and the first current conductor of the second facility are connected to each other in a laminar manner, preferably in a positive manner and/or non-positive manner, in particular in electric contact. Such an electric connection allows for a low contact resistance for the transfer from one to the other current conductor such as in a serial connection of the first and second facility.

Preferably, the heat conducting facility is connected in a positive manner and/or non-positive manner to the second current conductor of the first facility and/or with the first current conductor of the second facility. Thus, low losses in heat transport, respectively a good heat flow conductivity from the one or the two current conductors to the heat conducting facility is achieved.

The first current conductor of the first facility may be connected to a cathode of the first facility, and the second current conductor of the second facility may be connected to an anode of the second facility. Thus, a serial connection of the first and the second facility is achieved. The first current conductor of the first facility may form a negative terminal of the flat basis module, and the second current conductor of the second facility may form a positive terminal of the flat basis module.

According to another aspect of the present invention, a device is provided operating according to galvanic principles. The device comprises a first flat basis module as described above and a second flat module also as described above. The second flat basis module is arranged above the first flat basis module, wherein the first current conductor of the first facility of the second flat basis module is arranged above the first current conductor of the first facility of the first flat basis module, and the second current conductor of the second facility of the second flat basis module is arranged above the second current conductor of the second facility of the first flat basis module. Such a device allows for a further duplication of the capacity, and allows for an electric connection in parallel of the first and second flat basis module having short electric connection paths between the respective current conductors, and thus having a low electrical resistance in the electrical connection.

This device may be developed such that by making an electric connection via a suitable electric connecting system between the first current conductor of the first facility of the second flat basis module and the first current conductor of the first facility of the first flat basis module as well as an electric connection via a suitable electric connecting system between the second current conductor of the second facility of the flat basis module and the second current conductor of the second facility of the first flat basis module, a parallel connection of the flat basis modules may be formed.

The second current conductor of the second facility of the second flat basis module may be connected to the second current conductor of the second facility of the first flat basis module by means of an electric connecting system. Thereby, a parallel connection between the first and the second flat basis module is achieved.

The device may also comprise at least one further flat basis module or a multitude of further flat basis modules as described above, wherein the flat basis modules are arranged one upon the other such that for adjoining flat basis modules, respectively, the first current conductor of the first facility of the upper flat basis module is arranged above the first current conductor of the first facility of the flat basis module, which is adjoinedly arranged below, and the second current conductor of the second device of the upper flat basis module is arranged above the second current conductor of the second facility of the flat basis module, which is adjoinedly arranged below. In this manner, a nearly arbitrarily extendable stackability having a parallel connection of flat basis modules and a respective increase of the total capacity of the device is achieved.

Preferably, the first current conductor of the first facility of a respective flat basis module is connected to the first current conductor of the first facility of a respective adjoining flat basis module by means of an electric connecting system. Similarly, preferably, the second current conductor of the second facility of a respective flat basis module is connected to the second current conductor of the second facility of a respective adjoining flat basis module by means of an electric connecting system. In this manner, a parallel connection of the flat basis modules is formed, and electric connections having short paths are facilitated.

According to a further aspect of the present invention, a device is provided operating according to galvanic principles, and which comprises the following: A first flat basis module as described above, and a second flat basis module as also described above. The second flat basis module is arranged above the first flat basis module, wherein the first current conductor of the first facility of the second flat basis module is arranged above the second current conductor of the second facility of the first flat basis module, and the second current conductor of the second facility of the second flat basis module is arranged above the first current conductor of the first facility of the first flat basis module. In this manner, the possibility of a serial connection of the two flat basis modules having short electric connection paths, and thus a low electric resistance in an electric interconnection is facilitated.

Preferably, the device is developed such that by providing an electric connection by means of a suitable electric connecting system between the second current conductor of the second facility of the first flat basis module and the first current conductor of the first facility of the second flat basis module, a serial connection of the flat basis modules may be formed.

Preferably, the second current conductor of the second facility of the first flat basis module is connected to the first current conductor of the first facility of the second flat basis module by means of an electrically conductible connecting system. Thereby, a serial connection of the flat basis modules is formed.

The device may comprise at least one further flat basis module, or a multitude of further flat basis modules as described above. Thereby, the flat basis modules are arranged one upon the other such that for a respective flat basis module the first current conductor of the first facility of the respective flat basis module is arranged below the second current conductor of the second facility of the flat basis module, which is adjoinedly arranged above, and the second current conductor of the second facility of the respective flat basis module is arranged below the first current conductor of the first facility of the flat basis module, which is adjoinedly arranged above.

Preferably, the first current conductor of the first facility of a respective medium flat basis module is connected to the second current conductor of the second facility of a flat basis module, which is adjoinedly arranged below by means of an electric connecting system, and the second current conductor of the second facility of a respective flat basis module is connected to the first current conductor of the first facility of a flat basis module, which is adjoinedly arranged above by means of an electric connecting system. Thus, a serial connection of the flat basis modules is formed.

A device according to the invention according to the previously mentioned aspect of the invention regarding the serial connection of flat basis modules, and a device according to the invention according to the previously mentioned aspect of the invention regarding the parallel connection of flat basis modules, may be performed such that adjoining flat basis modules are stacked one upon the other, respectively, in particular having an interposed, preferably thin, preferably electrically isolating and still further preferred vibration-reducing, flexible foil and/or layer, or also in direct housing contact of housings, which are arranged one upon the other, and which are arranged side by side. Thus, a mechanically compact assembly of the flat basis modules is achieved.

Preferably, the respective current conductors being arranged one upon the other are connected to each other in an electrically conductible manner by means of at least one rigid electric connecting system. Alternatively, the respective current conductors being arranged one upon the other are connected to each other in an electrically conductible manner by means of at least one flexible electric connecting system.

Preferably, in a device comprising the described mechanical assembly, in each pair of adjoining current conductors, which are connected each by means of an electric connecting system, at least one current conductor and/or at both current conductors a heat conducting facility is connected to the respective current conductors in heat flow communication. It is further preferred that with each current conductor a heat conducting facility is connected to the current conductor in heat flow communication. In this manner, the heat can be conducted still more effective from the interior of the facilities being connected to each other from the respective adjoining flat basis modules, which are stacked one upon the other.

Preferably, a respective heat conducting facility has an elongated form having a longitudinal direction, which essentially completely covers the respective current conductor, and which protrudes in the longitudinal direction at least in one direction over the extension of the current conductor in the longitudinal direction thereof. Preferably, the heat conducting facility extends in its longitudinal direction over the extension of the housing surface from which the respective current conductor protrudes. In this manner, even in case of a mechanical mounting, respectively stacking of the flat basis modules that are arranged one upon the other, or which are adjoining to each other, the protruding ends of the heat conducting facilities are easily accessible, respectively connectable to a receiving facility for thermal energy, as described below.

The devices according to the aforementioned aspects of the invention may comprise two or more stacks of flat basis modules, which are arranged one upon the other.

According to another aspect of the present invention, yet another device operating according to galvanic principles is provided. This device comprises a first facility as described above, and a second facility as also described above. The second facility is arranged above the first facility, wherein the first current conductor of the second facility is arranged above the first current conductor of the first facility, and the second current conductor of the second facility is arranged above the second current conductor of the first facility. In this manner, the first and second facility may be easily electrically connected in parallel, and may be mechanically compactedly arranged one upon the other.

Preferably, the device is developed such that by means of making a first electric connection by means of a suitable, first electric connecting system between the first current conductor of the second facility, and the first current conductor of the first facility as well as a second electric connection by means of a suitable, second electric connecting system between the second current conductor of the second facility and the second current conductor of the first facility, a parallel connection of the facilities is formed.

The device may comprise at least one further facility or a multitude of further facilities as described above, wherein the facilities are arranged one upon the other such that the respective first current conductors of the facilities and the respective second current conductors of the facilities are arranged one upon the other, respectively.

Preferably, pairs of the first current conductors of the respective facilities are connected to each other in an electrically conductible manner by means of an electric connecting system, respectively, and the second current conductors of the facilities are connected to each other in an electrically conductible manner by means of an electric connecting system, respectively. Thereby, a parallel connection of the facilities is formed.

According to a still further aspect of the invention, a device is provided operating according to galvanic principles and which comprises the following: A first facility as described above and a second facility as described above, wherein the second facility is arranged above the first facility, and wherein the first current conductor of the second facility is arranged above the second current conductor of the first facility, and the second current conductor of the second facility is arranged above the first current conductor of the first facility.

The device can be developed such that by making an electric connection by means of a suitable electric connecting system between the first current conductor of the second facility and the second current conductor of the first facility, a serial connection of the facilities may be formed.

The device may comprise at least one further facility or a plurality of further facilities as described above, wherein the facilities are arranged one upon the other such that the first current conductor, which is arranged above a respective facility of an adjoining facility, is arranged above a respective second current conductor of the respective facility.

Preferably, in the device, the first current conductor of a facility, which is adjoinedly arranged above the respective facility, is connected to a respective second current conductor of the respective facility by means of an electric connecting system such that a serial connection of the facilities, which are arranged one upon the other, is formed.

The devices according to the aforementioned both aspects may have two or more stacks of facilities, which are stacked one upon the other.

In the devices disclosed above according to the different aspects of the invention, the stacks of flat basis modules, respectively facilities may be arranged side by side in a linear, bi-linear or multi-linear arrangement.

In these devices, at least two or more linear, bi-linear or multi-linear arrangements may be arranged side by side and/or one upon the other.

In the stacking, respectively the arrangement of stacks side by side, between the facilities being arranged one upon the other, respectively side by side, respectively, one or more, in particular thin, preferably electrically isolating, preferably vibration-reducing, preferably flexible, foil or layer may be arranged.

The device disclosed above, the flat basis module disclosed above, and the devices disclosed above according to the different aspects of the present invention may further comprise a receiving facility for thermal energy. The receiving facility is coupled in heat flow communication to one or more heat conducting facilities for receiving thermal energy, which has been dissipated from the one or the several heat conducting facilities. The receiving facilities for thermal energy may, if suitably constructed, improve the heat dissipation from the interior of the facility, respectively the facilities, which are connected to each other.

The conducting facility may be suitably tempered and, preferably, may be cooled. Thereby, a heat sink is formed, which receives the heat flow that is conducted from the facilities via the current conductors and the heat conducting facilities, and thus still better reduces a temperature increase during operation of the facilities.

Further preferred embodiments can be taken from the attached drawings. Herein show:

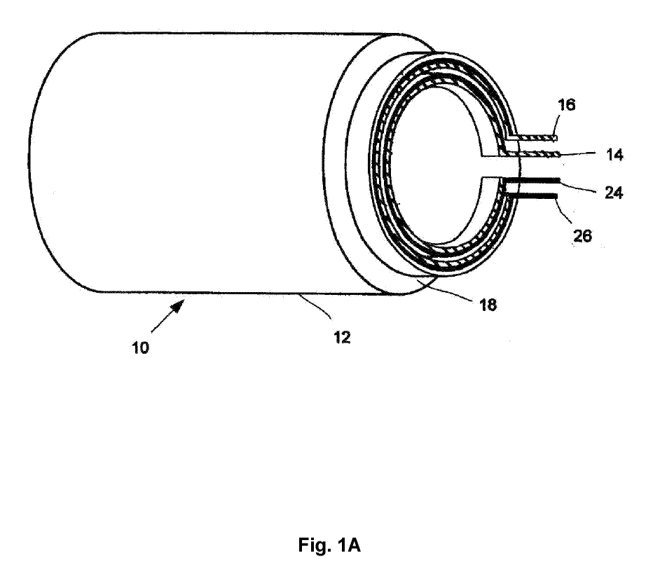

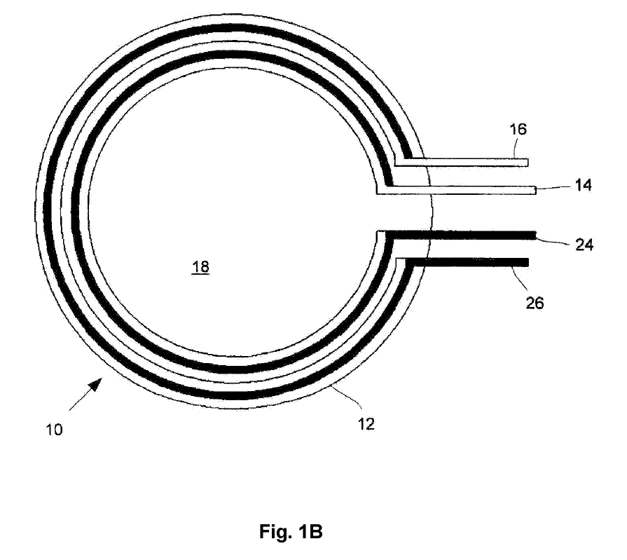

FIG. 1A is a perspective schematic view of an essentially cylindrical facility according to the invention, which is provided with current conductors and heat conducting facilities, and FIG. 1B is a view in axial direction of the facility from FIG. 1A.

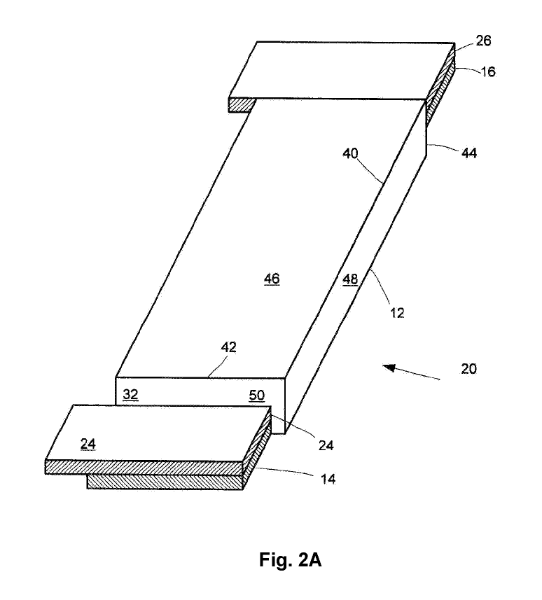

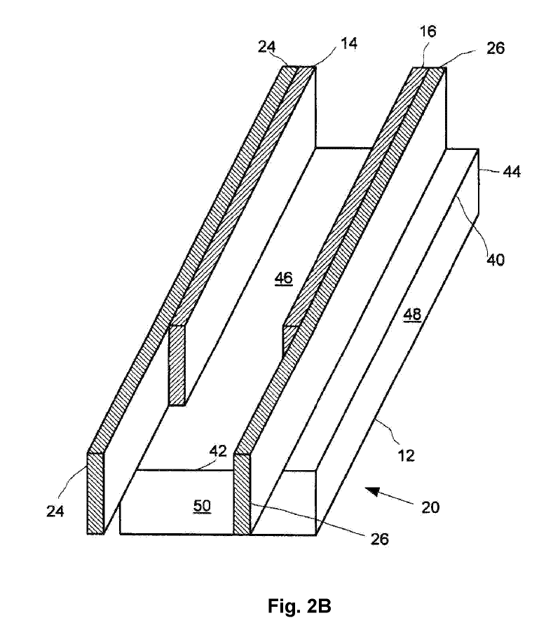

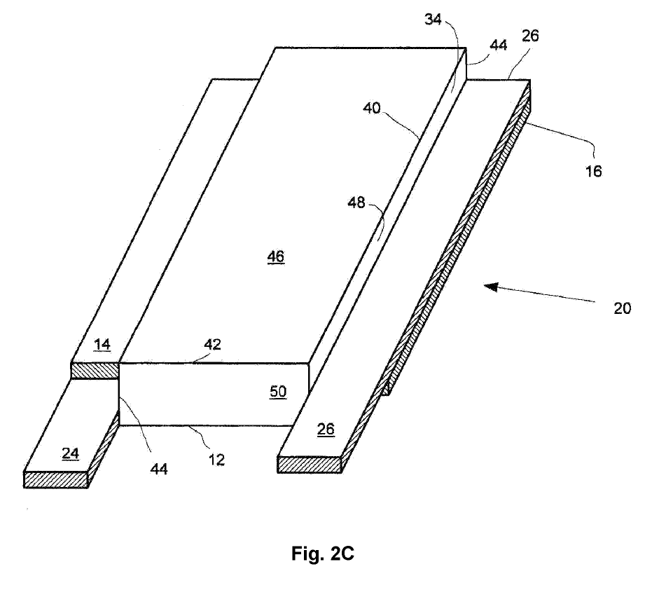

FIG. 2A to 2C are perspective schematic views of three different embodiments of essentially cuboid-shaped facilities according to the invention.

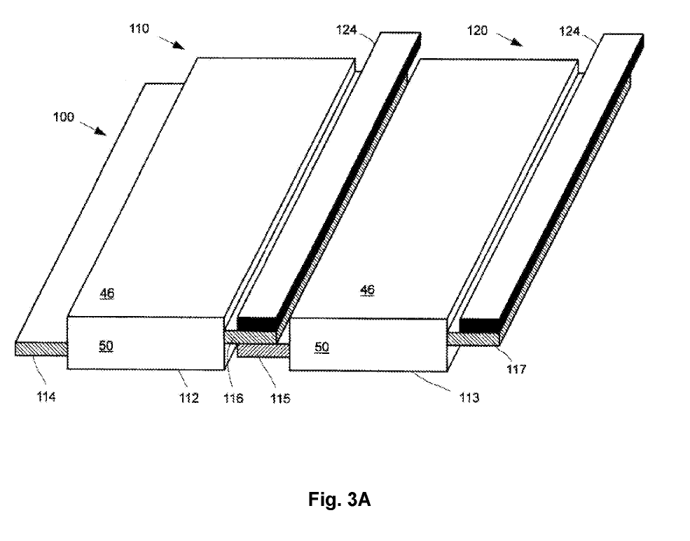

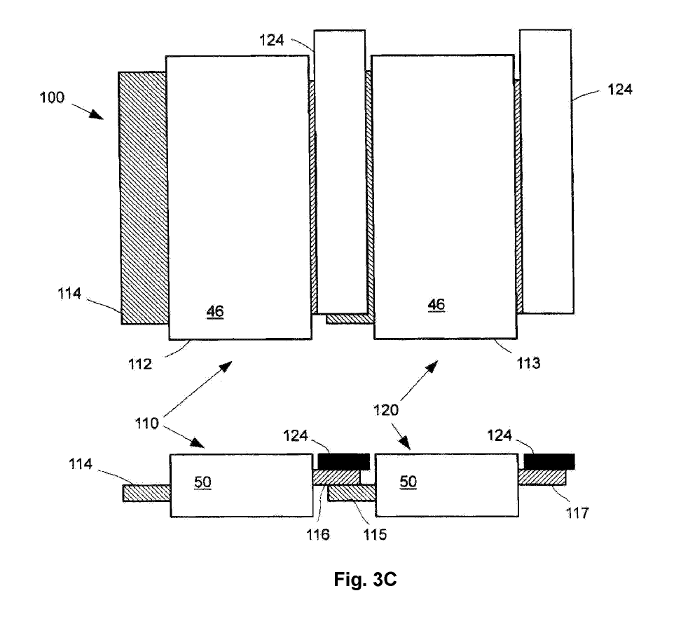

FIG. 3A is a perspective schematic view, FIG. 3B is a schematic top view, and FIG. 3C is a schematic top view of the front of a flat basis module according to the invention.

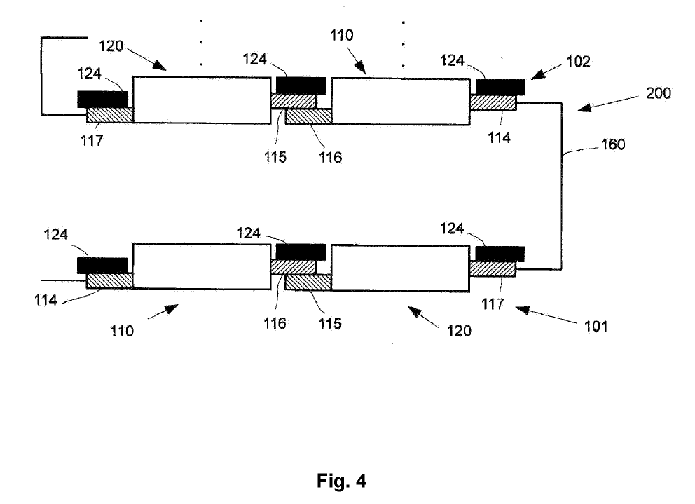

FIG. 4 is a schematic top view on the end surfaces of two flat basis modules according to the invention of FIG. 3, which are connected to a serial connection.

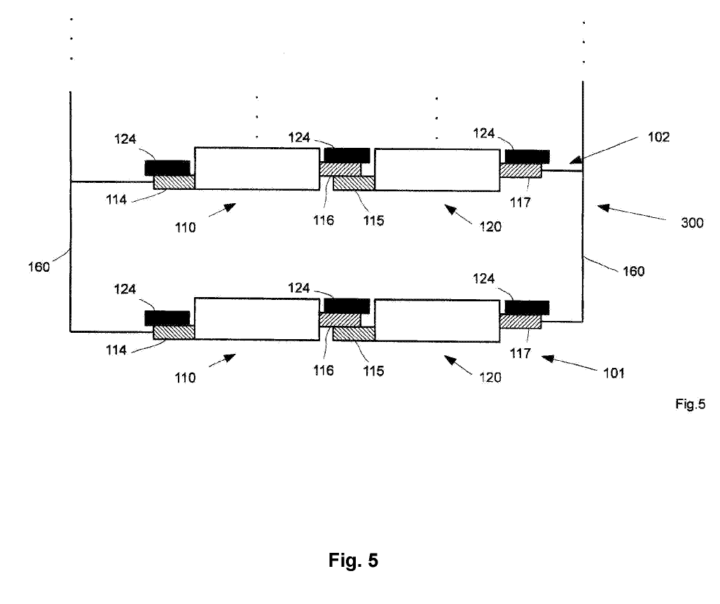

FIG. 5 is a schematic top view on the end surfaces of two flat basis modules according to the invention of FIG. 3, which are connected to a parallel connection.

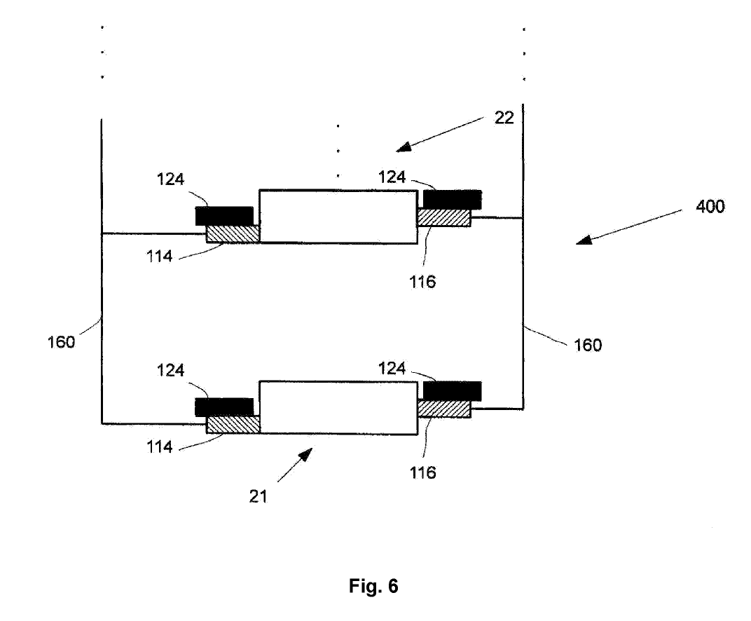

FIG. 6 is a schematic top view on the end surfaces of two facilities according to the invention from FIG. 2C, which are connected to a parallel connection.

FIG. 1 shows as an example of a facility operating according to galvanic principles an accumulator 10. FIG. 1A shows a perspective schematic view of the essentially cylindrical accumulator 10, and FIG. 1B shows a top view seen in direction of a longitudinal axis of an end surface 18 of the accumulator 10 from FIG. 1A. As shown in FIG. 1A, the facility 10 comprises an essentially cylindrical housing 12 comprising a first end surface 18, and a second end surface that is not shown, which is arranged to the first end surface in axial direction of the side opposing the housing 12. The facility 10 further comprises a first current conductor 14, a second current conductor 16, a first heat conducting facility 24 and a second heat conducting facility 26. As shown in FIGS. 1A and 1B, the first current conductor 14 and the second current conductor 16 protrude from the first end surface 18. A portion of the end surface 18, which is broken through from the protruding first current conductor 14, has the form of a nearly completely closed circular ring having a smaller radius, and a portion of the end surface 18, which is broken through from the second current conductor 16, also has the form of a nearly completely closed circular ring having a greater radius than the internal, nearly completely closed circular ring that is attributed to the first current conductor 14. There, where the internal circular ring is interrupted, the first current conductor has an attachment piece guiding essentially radially outwards, which serves as first current connection terminal, respectively voltage connection terminal of the accumulator 10, which is accessible from the exterior. On the outer side of the cylindrical section of the portion of the first current conductor 14 protruding from the end surface 18, the first heat conducting facility 24 is mounted in a positive and non-positive manner. There, where the circular ring is not closed, and at the free end, i.e. where the section of the first current conductor 14 being arranged in a radially manner in an external connection, is not mounted, the first heat conducting facility 24 has a protruding section in an essentially external connection. This section serves for the connection, respectively connecting, of the first heat conducting facility 24 from the external connection to a, respectively with, receiving facility for thermal energy (not shown). By means of the positive and non-positive mounting of the first heat conducting facility 24 to, respectively with the first current conductor 14, a laminar heat flow communication between the first current conductor 14 and the first heat conducting facility 24 is achieved.

The second current conductor 16 and the second heat conducting facility 26 are structurally developed in a comparable manner with the first current conductor 14 and the first heat conducting facility 24, only that the diameter of the cylindrical segments of the second current conductor 16 and the second heat conducting facility are greater than the respective diameters of the cylindrical segments of the first current conductor 14 and the first heat conducting facility 24, as shown in FIGS. 1A and 1B.

An essentially cylindrical cathode and an essentially cylindrical anode are arranged in a nested manner within the interior of the essentially cylindrical housing 12 such that the cathode is connected to the cylindrical segment of the first current conductor 14, which extends into the interior of the housing 12, in an electrically conductible manner, and that the anode is connected to the cylindrical segment of the second current conductor 16, which extends into the interior of the housing 12, in an electrically conductible manner. Thus, the connections between the first, respectively the second current conductor 14, 16 and the cathode (not shown), respectively the anode (not shown), exhibit an in essential circular sectional area, which provides a nearly maximal sectional area for the conduction of current from the cathode, respectively the anode, to the respective connected current conductors.

In an alternative of the first embodiment that is shown in FIGS. 1A and 1B of a facility 10 according to the invention, the second current conductor 16 and the second heat conducting facility 26 are arranged on the end surface of the housing 12 (not shown), which opposes the visible end surface 18 in the FIGS. 1A and 1B. In another alternative, additionally to the first current conductor that is arranged on the first end surface 18 with the first heat conducting facility 24, and the second current conductor 16 with the second heat conducting facility 26, also respective current conductors and heat conducting facilities are arranged on the end surface opposing the end surface 18, which is not shown in the FIGS. 1A and 1B. Thereby, the current conductors and heat conducting facilities, which are arranged on the not shown end surface, are developed such that the first accumulator 10 can be assembled with a second accumulator, which essentially has the same construction, in direction of its cylinder axis such that electrically conductible connections, respectively, between the first, respectively internal current conductor, respectively the second, respectively external current conductor on the end surface of the second accumulator with the first current conductor 14, respectively the second current conductor 16 on the end surface 18 of the first accumulator 10, are formed such to achieve an electric parallel connection of the first and second accumulator. In this manner, not only two but also three or any number of further accumulators may be assembled in their longitudinal direction.

FIG. 2 shows different alternatives of a second embodiment of an accumulator 20 according to the invention comprising an essentially cuboid-shaped housing 12. The cuboid-shaped housing is developed in a flat construction, and therefore comprises a first and a second largest housing surface 64, which opposes the first housing surface, and which is bordered by the longest edges 40 and the second longest edges 42; a first and a second largest housing surface 48, which opposes the first housing surface, and which is bordered from longest edges 40 and shortest edges 44; and a first and a second smallest housing surface 50, which opposes the first housing surface, and which is bordered from the second longest edges 42 and shortest edges 44. The first, respectively second largest housing surface 16, are also termed in the following as upper, respectively lower housing surface. The first, respectively the second largest housing surface 46, are also termed in the following as first, respectively left and second respectively right lateral surfaces, wherein the terms “left”, respectively “right”, relate to the relative arrangement in the view of the FIGS. 2A to 2C. The first and second smallest housing surface 50 are in the following also termed as front, respectively rear end surface, wherein the term “front” and “rear” in turn relate to the view of FIG. 2.

FIG. 2A shows a schematic perspective view of an accumulator 20 comprising a cuboid-shaped housing 12, from which (in the view of FIG. 2A) front end surface a first current conductor 14 protrudes, and on the opposing (in the view of FIG. 2A rear) end surface 44 a second current conductor 16 protrudes. The portions of the current conductor 14, respectively 16, protruding from the housing, have an even, rectangular, elongated form being arranged in parallel with respect to a largest housing surface 46, and are aligned in their longitudinal direction in parallel with respect to one, respectively the second longest edges 42. At the first, respectively second current conductor 14, respectively 16, a first, respectively second heat conducting facility 24, respectively 26, are mounted in particular in a positive and non-positive manner, respectively, for making the heat flow communication. The heat conducting facilities 24 and 26 essentially cover the total even side, respectively surface of the portion of the current conductor 14 respectively 16, protruding from the housing 12, respectively. Therefore, the heat conducting facilities 24, 26 also have an elongated form. They protrude in their longitudinal direction over the respective length dimension of the even contact area of the respective current conductor 14, respectively 16 (in the view shown in FIG. 2A towards the left side). The heat conducting facilities 24 and 26 also protrude over the boarder of the housing surfaces 50, which is formed by the shortest edge 44, from which the current conductors 14 and 16 protrude, in the view shown in FIG. 2A towards the left side.

In the embodiment of FIG. 2A, one, two or more accumulators 20 may be compactedly mechanically stacked one upon the other, preferably such that the accumulators 20 are located on each other with their largest housing surfaces 46 without a noteworthy clearance, and thus form a stack comprising one, two or more accumulators 20. The heat conducting facilities 24 and 26 then protrude over the respective second largest housing surfaces 48 of the respective accumulators 20, which are stacked one upon the other, and thus are easily accessible from the exterior, and are easily to contact for the connection to a heat conductance facility (not shown) for thermal energy in heat flow communication. Two respective arrangements of stacks of accumulators 20 may be also assembled directly side by side in a “back-to-back”-arrangement, wherein the heat conducting facilities of the second stack protrude over one side, which opposes the side of the first stack from which the heat conducting facility of the first stack protrudes.

In an alternative of the embodiment shown in FIG. 2A, the heat conducting facilities 24 and 26 do not protrude over the respective current conductors 14 and 16 in direction of the second longest edge 42 (in FIG. 2A towards the left side), however in direction of a longest edge 40 (in FIG. 2A towards the right side), and the second heat conducting facility 26 in an opposite direction (in the view shown in FIG. 2A towards the rear side). This alternative has the advantage that not only two stacks of accumulators 20 may be arranged side-by-side in a “back-to-back”-arrangement, however that any number of further stacks of accumulators may be directly arranged side by side, wherein for a compact arrangement only a minimal or no clearance is free between the second largest housing surfaces 48 of the accumulators 20 in the different stacks.

FIG. 2B shows another embodiment of the arrangement of the current conductors in the housing 12. In this arrangement, the first current conductor 14 and the second current conductor 16 protrude from the same largest housing surface 46, have an elongated form and extend in a direction parallel to the longest edge 40 of the cuboid-shaped housing 20. The first, respectively second heat conducting facility 24, respectively 26, is positively and non-positively mounted on the portion of the first, respectively second current conductor 14, respectively 16, which protrude from the housing 12, more precisely from the largest housing surface 46. Consequently, the first and the second heat conducting facility 24 and 26 are also elongated and protrude in their longitudinal direction not only over the borders of the first, respectively second current conductor 14, respectively 16, but also over the second longest edge 42 of the housing 12, which borders the housing surface 46.

The alternative shown in FIG. 2B of the second embodiment of an accumulator has the following advantages. Two accumulators, which essentially have the same construction, may be stacked one upon the other, respectively, such that the largest housing surfaces 46 from which the current conductors 14, 16 protrude, oppose each other and, if the current conductors are suitably developed, the respective first current conductors 14 come in electric contact with each other, and the second current conductors 16 also come in electric contact with each other such that an electric parallel connection of two accumulators 20 is formed, which are arranged one upon the other. By means of the extension direction of the current conductors 14 and 16 parallel to a longest edge 40 of the housing, the connection between the portion of the first, respectively second current conductor, which extends into the interior of the housing, with an electrode (cathode, respectively anode) of the accumulator is such that a particularly large sectional area for the conductance of the electric current form the electrodes into the current conductor, and for the heat flow from the electrodes into the current conductor 14, respectively 16, is provided. Additionally, the first and second heat conducting facility 24 and 26, which also have an elongated form, protrude in their longitudinal direction not only over the borders of the respective first and second current conductors 14 and 16, however also over the border formed by the edge 42 of the housing surface 46, from which the current conductors 14 and 16 protrude. Thereby, the protruding end sections of the heat conducting facilities 24 and 26 also in the configuration of one, two or more accumulators being stacked in pairs are accessible from the boundary layer, which is formed by the smallest housing surfaces 50, of a stack for the connection of heat conducting facilities 24 and 26 to a conducting facility (not shown) for thermal energy in heat flow communication, as set forth below.

The embodiment shown in FIG. 2B can be changed such that the second current conductor 16 and the second heat conducting facility 26 on the (in FIG. 2B not shown lower) housing surface, the housing surface 46, from which the first current conductor 14 protrudes, are arranged, and that on the housing surface 46 in place of the second current conductor 16, a current conductor contact area is provided, which is flush with the housing surface 46, or is only a little bit protruding or preferably a little bit backwardly arranged, and that on the housing surface that opposes the housing surface 46 (as shown in FIG. 2B), a current collecting conducting area is provided in a mirror-symmetrical manner with respect to the first current conductor 14, which is provided in flush with the housing surface, or is a little bit protruding or preferably a little bit backwardly arranged with respect to the housing surface. In this modification, two or any number of further accumulators can be stacked one upon the other. Thereby, between the largest housing surfaces of the accumulators being stacked one upon the other, clearances are created, respectively, which have an inner width that corresponds to the height of the first, respectively second current conductor from the largest housing surfaces. Thereby, when stacking, the first current conductor of a respective accumulator comes into electric contact with the respective current conductor area of an accumulator, which is adjoinedly arranged above, and the second current conductor of a respective accumulator comes into electric contact with the respective current collecting area of an accumulator which is adjoinedly arranged below within the stack. It is a matter of course that this does not apply to the accumulators that are arranged at the outer end of the stack. For accumulators being arranged at the ends of the stack, the respective current conductor for contacting are accessible form the exterior.

FIG. 2C shows a presently preferred embodiment of an accumulator 20 according to the invention having an essentially cuboid-shaped housing 12 in a flat construction. The first current conductor 14 is arranged on a second largest housing surface 48 of the housing 12, and the second current conductor 16 is arranged on the opposing second largest housing surface 48 of the right lateral surface that is shown in FIG. 2C. The portions of the first and second current conductor 14 and 16 protruding from the housing surface extend in parallel to the longest edge 40 of the cuboid-shaped housing 12. Thus, similar to FIG. 2B, for the connection to the electrodes of the accumulator that are arranged in the interior of the housing, a particular large sectional area for the current and heat conduction from the electrodes to the current conductors is possible. For making heat flow communication, on the first, respectively second current conductors 14, respectively 16, respectively, a first, respectively second heat conducting facility 24, respectively 26, are mounted, in particularly in a positive and or/non-positive manner. The heat conducting facilities 24, 26 protrude in their longitudinal direction from the current conductor not only over the extension of the current conductor 14, respectively 16, but also over the border by means of the shortest edge 24 of the second largest lateral surface 48. In this embodiment, an accumulator 20 is arbitrarily stackable in order to form stacks of two or more accumulators being arranged one upon the other. Thereby, the end sections of the heat conducting facilities 24, respectively 26, protruding over the smallest housing surfaces 50 of the accumulators 20, are accessible form the exterior for connecting to a conducting facility for thermal energy (not shown) in heat flow communication.

In the embodiments shown in FIGS. 1 and 2 of the accumulators 10, respectively 20 according to the invention, the first current conductor 14 is connected to the cathode of the accumulator in an electrically conductible manner, and the second current conductor 16 is connected to the anode of the accumulator.

FIG. 3 shows an assembly of two accumulators according to the invention in the alternative of the second embodiment from FIG. 2C to a device comprising two accumulators, which is termed flat basis module. FIG. 3A shows a schematic, perspective view of the flat basis module 100, FIG. 3B shows a top view on the flat basis module 100 that is shown in FIG. 3A, and FIG. 3C shows a schematic view from the front on the flat basis module 100 that is shown in FIG. 3A. The flat basis module comprises a first facility 110 and a second facility 120, which essentially have the same construction as accumulator 20 that is shown in FIG. 2C, respectively. As shown in FIGS. 3A and 3C, the first and second facilities 110 and 120 share a plane, which is parallel to the largest housing surfaces 46 of the housings 112 and 113 of the first and second facility 110 and 120, which are arranged side by side such that the height of the flat basis module 100 corresponds to the height of an individual facility of the facilities 110 and 120. In the flat basis module 100, the second largest housing surfaces, in FIG. 3A the right lateral surface of the facility 110 and the left lateral surface of the facility 120, are arranged such that they face each other. Thereby, the second current conductor 116 is very close to the first facility 110 of the first current conductor 115 of the second facility 120, preferably and as shown in FIG. 3A, even in direct contact and therefore also in electric contact therewith.

With regard to the embodiments shown in FIG. 3, and similarly also for the embodiments shown in the following FIGS. 4 to 6, applies that the first current conductor 114, respectively 115, of a respective facility 110, respectively 120, is connected to the cathode of the facility, and the second current conductor 116, respectively 117, of the first facility 110, respectively the second facility 120, is connected to the anode of the facility.

Consequently, in the flat basis module 100, the first facility 110 and the second facility 120 are connected to each other in an electrical serial connection, respectively in a connection in series. The first current conductor 114 of the first facility 110 and the second current conductor 117 of the second facility 120 protrude at opposing (second largest) lateral surfaces of the housing 112, respectively housing 113 of the first, respectively second facility 110, respectively 120, and are accessible from the exterior for the electrical contacting also when one, two or more flat basis modules are stacked one upon the other.

Alternatively to a direct electrical contact, the second current conductor 116 of the first facility 110 and the first current conductor 115 of the second facility 120 may be arranged spaced from each other, wherein by means of a suitable electric connecting system an electric conductibility is generated between these two current conductors.

Furthermore, the flat basis module comprises at least a heat conducting facility 124. This facility, as shown in FIGS. 3A to 3C, may be assembled in heat flow communication, in particularly in a positive and a non-positive manner, with the second electrode of the first facility 110, however, it also may be assembled in a positive and non-positive manner with the first current conductor 115 of the second facility 120, in FIGS. 3A and 3C from below, at the current conductor 115. The heat flow communication may be connected both to the second current conductor 116 of the first facility 110 and to the first current conductor 115 of the second facility 120, for example by interposing between the two current conductors 116 and 115 in heat flow communication, in particular in a positive and non-positive manner. Optionally, a second heat conducting facility may be provided such that the first heat conducting facility 124 is connected to the second current conductor 116 of the first facility 110, and the second heat conducting facility is connected to the first current conductor 115 of the second facility 120 in heat flow communication, in particularly in a positive and non-positive manner.

As shown in FIGS. 3A, 3B and 3C, optionally also another heat conducting facility may be connected to the second current conductor 117 of the second facility 120 in heat flow communication, in particular in a positive and non-positive connection. And, optionally, still another heat conducting facility may be provided in heat flow communication to the first current conductor 114 of the first facility 110, in particular in positive and non-positive connection.

End sections of the one or several heat conducting facilities 114 protrude (in the view of the FIG. 3A towards the rear side) from the smallest housing surface 50 of the first and second facility. Thus, even if two or more flat basis modules 100 are stacked one upon the other, the end sections are accessible from the exterior for the connection to a conducting facility for thermal energy in heat flow communication.

FIG. 4 shows a device 200, which is obtained by stacking two flat basis modules 101 and 102. The second flat basis module 102 is arranged above the first flat basis module such that the first current conductor 114 of the first facility 110 of the second flat basis module 102 is arranged above the second current conductor 117 of the first facility 110 of the first flat basis module 101, and is thus in a relatively tight spatial proximity to this module. Accordingly, the second current conductor 117 of the second facility 120 of the second flat basis module 102 is above and in close spatial proximity to the first current conductor 114 of the first facility 110 of the first flat basis module. Furthermore, the first current conductor 114 of the first facility 110 of the second flat basis module 102 is connected to the second current conductor 117 of the first facility 110 of the first flat basis module 101 in an electrically conductible manner by means of a suitable electric connecting system 160. Thus, the first flat basis module 101 and the second flat basis module 102 are connected in an electrical serial connection, respectively in a connection in series. A third flat basis module and any number of further flat basis modules also can be stacked onto the connection of the first and second flat basis module 101 and 102, wherein the first current conductor 114 of a first facility of a flat basis module, respectively, which is to be adjoinedly arranged on the top of the stack above the second current conductor 117 of the second facility 120, which up to then is arranged as the topmost flat basis module within the stack, and is connected to this module by means of an electric connecting system 160. Thus, a serial connection of 2, 3 or any number of further flat basis modules may be obtained.

In order to allow for an optimal heat dissipation, in each flat basis module of the device 200, a heat conducting facility 114 is connected in heat flow communication on the first current conductor 114 of the first facility and/or on the second current conductor 117 of the second facility 120, respectively, in particular connected in a positive and non-positive manner.

FIG. 5 shows a device 200, which is assembled from two flat basis modules 101 and 102. The second flat basis module is arranged above the first flat basis module 101 such that the first current conductor 114 of the first facility 110 of the second flat basis module 102 is arranged above the first current conductor 114 of the first facility 110 of the first flat basis module 101, and is electrically connected to said module by means of an electric connecting system 160, and such that the second current conductor 117 of the second facility 120 of the second flat basis module 102 is arranged above the second current conductor 117 of the second facility 120 of the first flat basis module 101, and is connected to said module by means of an electric connecting system 116. In this manner, an electric parallel connection of the first and second flat basis module 101 and 102 is achieved.

A third and any number of further flat basis modules may be arranged above the first and second basis flat module 101 and 102 of the device 300 shown in FIG. 5 such that the first current conductor of the first facility of a flat basis module to be added on the top of the stack is arranged above the first current conductor 114 of the first facility 101 of the topmost basis flat module within the stack, respectively, and correspondingly the second current conductor of the second facility of the basis flat module to be added to the stack is arranged above the second current conductor 117 of the second facility 120 of the topmost basis flat module being arranged within the stack. Thereby, adjoining first current conductors 114 of the first facility, respectively, of a respective basis flat module are connected in an electrically conductible manner to adjoining first current conductors 114 of the first facility of adjoining basis flat modules, and the second current conductors 124 of the second facilities 120 of respective adjoining basis flat modules by means of suitable electric connection facilities 160. Thereby, within the device 300, a parallel connection of two, three or any number of further basis flat modules is generated.

Similar to the device 200 from FIG. 4, also for device 300 from FIG. 5 applies that each basis flat module may exhibit within the stack three heat conducting facilities 124. Thereby, a first heat conducting facility may be connected to the first current conductor 114 of the first facility 110, a second heat conducting facility to the second current conductor 116 of the first facility 110, and/or to the first current conductor 115 of the first facility 120, and a third heat conducting facility 124 to the second current conductor 117 of the second facility in heat flow communication, in particular in a positive and non-positive manner, for an optimal heat dissipation via the respective current conductors from the respective electrodes of the facilities 110, respectively 120.

FIG. 6 shows an assembly in electric parallel connection of two facilities 21 and 22 operating according to galvanic principles, which are stacked one upon the other. The second facility is arranged above the first facility 21 such that the first current conductor of the second facility 22 is arranged above the first current conductor 114 of the first facility 21, and is electrically connected to said current conductor by means of an electric connecting system 160, and such that the second current conductor 116 of the second facility 22 is arranged above the first current conductor 116 of facility 21, and is electrically connected to said conductor via an electric connecting system 160. On said assembly of the first facility 21 and the second facility 22, a third and any number of further facilities may be stacked having essentially the same construction and, thereby, by means of electric connection facilities, in electric connections of respective adjoining first current conductors and respective adjoining second current conductors 116, an electric parallel connection of the facilities 21, 22, . . . may be achieved among each other. For an optimal heat dissipation, each first and second current conductor 114 and 116 of a respective facility 21, 22, . . . is connected within the stack in heat flow communication to a heat conducting facility 124, in particular in a positive and non-positive manner.

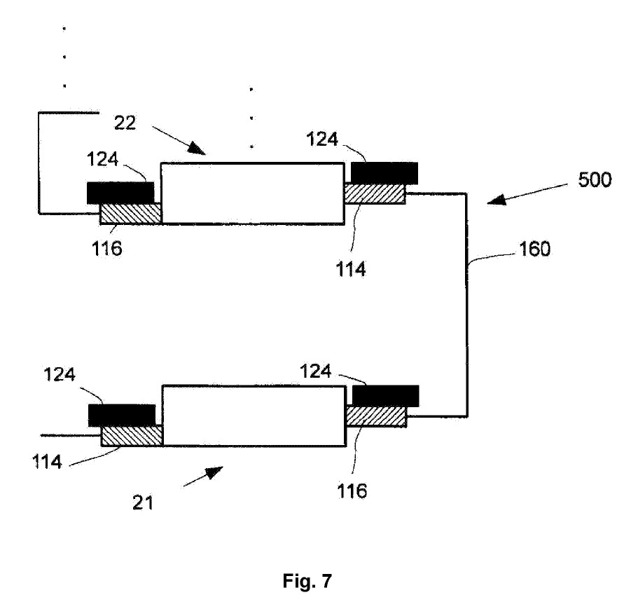

Finally, FIG. 7 shows a device 500 comprising an electric interconnection of two facilities 21 and 22 being arranged one upon the other in a serial connection. The second facility 22 is arranged above the first facility 21 such that the first current conductor 114 of the second facility 22 is arranged in high spatial proximity to the second current conductor 116 of the first facility 21, and is connected to said current conductor in an electrically conductible manner by means of a suitable electric connecting system 160. Furthermore, the second heat conductor 116 of the second facility 22 is arranged above the first current conductor 114 of the first facility 21. The first and second facility 21 and 22 are electrically interconnected in series by means of an electric connecting system 160, respectively in a serial connection. By stacking a third and any number of further facilities, wherein a first current conductor of a facility to be added to the stack, respectively, is arranged above the second current conductor of the up to then topmost facility of the stack, and is connected to said facility by means of an electric connecting system in an electrically conductible manner, a connection in series, respectively a serial connection, of two, three or any number of further facilities may be achieved. For an optimal heat dissipation, at each first and second current conductor of a respective facility within the stack of the facilities of the device 500, a heat conducting facility 124 is connected to in heat flow communication, in particular in a positive or non-positive manner.

Due to their elongated form, the heat conducting facilities 24, 26, 124 shown in the FIGS. 2B, 2C and 3 to 7, may also be termed as heat-conducting finger. Such a heat-conducting finger is an element, which may be simply produced, having a thermal, preferably a high thermal conductivity. This element serves for the conducting of thermal energy from the current conductors. It may also be used for the feeding of thermal energy to the current conductors. Thus, the heat is conducted in a space-saving manner between the cavities generated by the contour of the cells in the exemplarily shown and claimed stack arrangements to the regions of the current conductor connection.

Between the flat basis modules being stacked one upon the other of the devices 200 and 300 shown in FIGS. 4 and 5, respectively the individual facilities 20, 21, 22 of the devices 400 and 500 shown in FIGS. 6 and 7, between the respective adjoining basis flat modules, respectively facilities, a thin, electrically isolating and/or vibration-reducing flexible foil or layer may be applied onto. The facilities may also be stacked in direct contact side by side to each other and one upon the other.

The heat conducting fingers are laterally led through the facility 20, 110, 120, respectively the flat basis module 100, 101, 102, respectively the devices 200, 300, 400, 500, and are connected by means of a suitable connection technique to a conducting facility for thermal energy, in particular to a heat sink. Said conducting facility, in particular a heat sink, takes up the heat flow by means of a suitable tempering, which has been transferred from the facilities operating according to galvanic principles, in particular galvanic cells, via the current conductor to the heat conducting finger, and removes said heat from the direct region of the facilities, respectively galvanic cells.

The further interconnection of individual facilities as shown in FIGS. 6 and 7, respectively the basis flat modules as shown in FIGS. 4 and 5, is performed such that a stack is formed, which may amount to a height of several meters, preferably, however, below one meter. Additionally, such stacks may be arranged side-by-side or one after another, and may be connected to each other corresponding to capacity requirements by electrically conductible rigid or flexible serial or parallel connection.

All features disclosed in the application submissions are claimed as being essential for the invention, provided they are individually or in combination novel over the prior art.

### REFERENCE NUMERALS

10 facility (e.g. with cylindrical housing)
12 housing
14 first current conductor
16 second current conductor
18 end surface
20 facility (e.g. cuboid-shaped housing)
21 first facility 20
22 second facility 20
24 first heat conducting facility
26 second heat conducting facility
32 first housing surface
34 second housing surface
36 third housing surface
38 fourth housing surface
40 longest edge
42 second longest edge
44 shortest edge
46 largest housing surface
48 second largest housing surface
50 smallest housing surface
100 flat basis module
101 first flat basis module 100
102 second flat basis module 100
110 first facility 20
120 second facility 20
112 first housing 12
113 second housing 12
114 first current conductor (of a first facility)
115 first current conductor (of a second facility)
116 second current conductor (of a first facility)
117 second current conductor (of a second facility)
124 heat conducting facility
160 electric connecting system
200 device (for parallel connection of flat basis modules 101, 102)
300 device (for serial connection of flat basis modules 101, 102)
400 device (for parallel connection of facilities 20)
500 facility (for serial connection of facilities 20)

1. Facility (10, 20) operating according to galvanic principles such as a battery, an accumulator, and a lithium-ion battery, comprising
a housing (12), at least one first current conductor (14), which protrudes from the housing and at least one first heat conducting facility (24), which is connected to the first current conductor (14) in heat flow communication, and which is developed such to conduct thermal energy from the first current conductor (14).

2. Facility (10, 20) according to claim 1, further comprising at least one second current conductor (16), which protrudes from the housing (12), and at least one second heat conducting facility (26), which is connected to the second current conductor (16) in heat flow communication, and which is developed such to conduct thermal energy from the second current conductor (16).

3. Facility (10, 20) according to claim 2, wherein the first current conductor (14) protrudes from a first housing surface (32) of the housing (12), the second current conductor (16) protrudes from a second housing surface (34) of the housing (12), and that the second housing surface (34) is arranged to oppose the first housing surface (32).

4. Facility (10, 20) according to claim 2, wherein the first, and second heat conducting facility is connected to the first, and second current conductor in one of a positive and a non-positive manner.

5. Facility (10, 20) according to claim 1, wherein at least the portion of the first current conductor (14), which protrudes from the housing (12) has an elongated form.

6. Facility (20) according to claim 1, wherein the housing (12) has an essentially cuboid-shaped form, and wherein portion of the first current conductor (14), which protrudes from the housing (12), extends along a longest edge (40) of housing (12).

7. Facility (20) according to claim 3, wherein the housing (12) has an essentially cuboid-shaped form, and wherein a portion of the first current conductor (14), which protrudes from the housing (12), extends in parallel to a longest edge (40) of the housing on a first housing surface (32), which is bordered by a longest edge (40) and a shortest edge (44) of the housing, and wherein a portion of a second current conductor (16), which protrudes from the housing (12) extends on a second housing surface (34), which opposes the first housing surface (32).

8. Facility according to claim 2, wherein the first current conductor (14) is connected to a cathode of the facility, and the second current conductor (16) is connected to an anode of the facility.

9. Facility according to claim 2, wherein the first current conductor (14) forms a negative terminal of the facility, and the second current conductor (16) forms a positive terminal of the facility.

10. Facility according to claim 1, wherein the housing (12) has an essentially cuboid-shaped form comprising two largest housing surfaces (46) opposing each other, which are termed as upper and lower housing surface, and two second largest housing surfaces (48) opposing each other, which are termed as first and second lateral surface, and which share with the upper and the lower housing surface one edge from the group of longest edges (40) of the housing (12), respectively, wherein the distance between the upper and the lower housing surface (46) is not greater than 30%, in particular not greater than 20%, and still more preferred not greater than 10% of the length of one edge from the group of the longest edges (40).

11. Facility (20) according to claim 10, wherein the first current conductor (14) protrudes from one of the two lateral surfaces (48) of the housing, and the second current conductor (16) protrudes from one of the two other lateral surfaces (48) of the housing opposing said one lateral surface, and extends in parallel to one edge from the group of the longest edges (40).

12. Facility (20) according to claim 10, wherein the housing (12) further comprises two smallest housing surfaces (50) opposing each other, which are termed as first and second end surfaces, and that the first current conductor (14) protrudes from one of the two end surfaces (50) and the second current conductor (16) protrudes from the other one of the two end surfaces (50).

13. Facility (10, 20) according to claim 1, wherein the first heat conducting facility (24) has an elongated form having a longitudinal direction, essentially completely covers the first current conductor (14), and protrudes in longitudinal direction at least into one direction over the respective extension of the current conductor (14).

14. Facility (20) according to claim 13, wherein the first heat conducting facility (24) extends in its longitudinal direction over the extension of the housing surface from which the first current conductor (14) protrudes.

15. Facility (10, 20) according to claim 4, wherein the facility (10, 20) is developed such that it may be coupled to at least a second facility (22), which essentially has the same construction, to a two-fold module, wherein the facility (10, 20) and at least the second facility (22) may be arranged in a shared plane such that the second current conductor (16) of facility (10, 20) may be laterally arranged and connected to the first current conductor (14) of the second facility (22) in electric contact.

16. Facility according to claim 2, wherein a receiving facility for thermal energy, which is coupled to one or several heat conducting facilities (24, 26) in heat flow communication for receiving thermal energy, which is dissipated by the one or the several heat conducting facilities (24, 26).

17. Flat basis module (100) of a facility operating according to galvanic principles, comprising:
a first facility (110) operating according to galvanic principles, which comprises a first housing (112) having an essentially cuboid-shaped form, a first current conductor (114), which protrudes from a first lateral surface or first end surface of the first housing (112), and a second current conductor (116), which protrudes from a second lateral surface or second end surface of the first housing (112), which opposes the first lateral surface, and
a second facility (120) operating according to galvanic principles, which comprises a second housing (113) having an essentially cuboid-shaped form, a first current conductor (115), which protrudes from a first lateral surface or first end surface of the second housing (113), and a second current conductor (117), which protrudes from a second lateral surface or second end surface of the second housing (113), which opposes the first lateral surface,
wherein the first and second facility (110, 120) are arranged such that the first housing (112) of the first facility (110) is arranged with the second housing (113) of the second facility (120) in a shared plane such that the housing of the first facility is arranged in a shared plane with the housing of the second device such that the housing surface of the first facility from which the second current conductor of the first facility protrudes, faces the housing surface of the second facility from which the first current conductor of the second facility protrudes,
wherein preferably the second current conductor (116) of the first facility (110) is connected to the first current conductor (115) of the second facility (120) in electrical contact, characterized by a heat conducting facility (124), which is connected to the second current conductor (116) of the first facility (110) in heat flow communication, or to the first current conductor (115) of the second facility (120), for conducting thermal energy.

18. Flat basis module (100) according to claim 17, wherein the second facility (120) essentially has the same construction as the first facility (110).

19. Flat basis module (100) according to claim 17, wherein the second current conductor (116) of the first facility (110), and the first current conductor (115) of the second facility (120) are connected to each other preferably in laminar, electric contact, preferably in a positive or non-positive manner.

20. Flat basis module (100) according to claim 17, wherein the heat conducing facility (124) is connected to one of the second current conductor (116) of the first facility (110) and to the first current conductor (115) of the second facility (120) in one of a positive and a non-positive manner.

21. Flat basis module (100) according to claim 17, wherein the first current conductor (114) of the first facility (110) is connected to a cathode of the first facility, and the second current conductor (117) of the second facility (120) is connected to an anode of the second facility.

22. Flat basis module (100) according to claim 17, wherein the first current conductor (114) of the first facility (110) forms a negative terminal of the flat basis module (100), and the second current conductor (117) of the second facility (120) forms a positive terminal of the flat basis module.

23. Device (200) operating according to galvanic principles, comprising:
a first flat basis module (101), and a second flat basis module (102) according to claim 17, wherein the second flat basis module (102) is arranged above the first flat basis module (101), and wherein the first current conductor (114) of the first facility (110) of the second flat basis module (102) is arranged above the first current conductor (114) of the first facility (110) of the first flat basis module (101), and the second current conductor (117) of the second facility (120) of the second flat basis module (102) is arranged above the second current conductor (117) of the second facility (120) of the first flat basis module (110).

24. Device according to claim 23, wherein the device is developed such that by making an electric connection by means of a suitable electric connecting system (160) between the first current conductor (114) of the first facility (110) of the second flat basis module (102) and the first current conductor (114) of the first facility (110) of the first flat basis module (101) as well as an electric connection by means of a suitable electric connecting system (160) between the second current conductor (117) of the second facility (120) of the second flat basis module (102) and the second current conductor (117) of the second facility (120) of the first flat basis module (101), a parallel connection of the flat basis modules (101, 102) may be formed.

25. Device according to claim 23, wherein the second current conductor (117) of the second facility (120) of the second flat basis module (102) is connected to the second current conductor (117) of the second facility (120) of the first flat basis module (101) by means of an electric connecting system (160).

26. Device (200) according to claim 23, wherein at least one further flat basis module or a multitude of further flat basis modules according to are arranged one upon the other such that for adjoining flat basis modules, respectively, the first current conductor of the first facility of the top flat basis module is arranged above the first current conductor of the first facility of the flat basis module, which is adjoinedly arranged below, and the second current conductor of the second facility of the top flat basis module is arranged above the second current conductor of the second facility of the flat basis module, which is adjoinedly arranged below.

27. Device (200) according to claim 23, wherein the first current conductor of the first facility of a respective flat basis module is connected to the first current conductor of the first facility of an adjoining flat basis module, respectively, by means of an electric connecting system, and that the second current conductor of the second facility of a respective flat basis module is connected to the second current conductor of the second facility of an adjoining flat basis module, respectively, by means of an electric connecting system such that a parallel connection of the flat basis modules is formed.

28. Device (300) operating according to galvanic principles comprising:
a first flat basis module (101) and
a second flat basis module (102)
wherein the second flat basis module (101) is arranged above the first flat basis module (101), and wherein the first current conductor (114) of the first facility (110) of the second flat basis module (102) is arranged above the second current conductor (117) of the second facility (120) of the first flat basis module (102), and the second current conductor (117) of the second facility (120) of the second flat basis module (102) is arranged above the first current conductor (114) of the first facility (110) of the first flat basis module (101).

29. Device (300) according to claim 28, wherein the device is developed such that by making an electric connection by means of a suitable electric connecting system (160) between the first current conductor (114) of the first facility (110) of the second flat basis module (102) and the second current conductor (117) of the second facility (120) of the first flat basis module (101) as well as an electric connection by means of a suitable electric connecting system (160) between the second current conductor (117) of the second facility (120) of the second flat basis module (102) and the first current conductor (114) of the first facility (110) of the first flat basis module (201), a serial connection of the flat basis modules (101, 102) may be formed.

30. Device (300) according to claim 28, wherein the first current conductor (114) of the first facility (110) of the second flat basis module (102) is connected to the second current conductor (117) of the second facility (120) of the first flat basis module (101) by means of an electric connecting system (160).

31. Device according to claim 28, further comprising one of at least one flat basis module
wherein the flat basis modules of the device are arranged one upon the other such that for a respective flat basis module the first current conductor of the first facility of the respective flat basis module is arranged above the second current conductor of the second facility of the flat basis module, which is adjoinedly arranged below, and the second current conductor of the second facility of the respective flat basis module is arranged below the first current conductor of the first facility of the flat basis module, which is adjoinedly arranged above.

32. Device according to claim 31, wherein the first current conductor of the first facility of a respective medium flat basis module is connected to the second current conductor of the second facility of a flat basis module, which is adjoinedly arranged below by means of an electric connecting system, and that the second current conductor of the second facility of the respective medium flat basis module is connected to the first current conductor of the first facility of a flat basis module, which is adjoinedly arranged above by means of an electric connecting system such that a serial connection of the flat basis modules is formed.

33. Device according to claim 28, wherein the respective adjoining flat basis modules (101, 102) are stacked one upon the other.

34. Device according to claim 29, wherein at least one rigid electric connecting system (160), which connects current conductors being arranged one upon the other in an electrically conductible manner to each other, respectively.

35. Device according to claim 29, wherein at least one flexible electric connecting system (160), which connects current conductors being arranged one upon the other in an electrically conductible manner to each other, respectively.

36. Device according to claim 28, further comprising a pair of adjoining current conductors, which are connected by means of an electric connecting system, and at least one current conductor a heat conducting facility connected to said current conductor in heat flow communication.

37. Device according to claim 28, wherein at each current conductor (114, 115, 116, 117) a heat conducting facility (124) is connected to said current conductor in heat flow communication.

38. Device according to claim 28, wherein a respective heat conducting facility (124) has an elongated form having a longitudinal direction, essentially completely covers the respective current conductor (114, 115, 116, 117), and protrudes in longitudinal direction in at least one direction over the respective extension of the current conductor.

39. Device according to claim 38, heat conducting facility (124) extends in its longitudinal direction over the extension of the housing surface from which the respective current conductor (114, 115, 116, 117) protrudes.

40. Device (200, 300) according to claim 23, wherein the device (200, 300) comprises two or more stacks of flat basis modules (101, 102) being arranged one upon the other.

41. Device (400) operating according to galvanic principles, comprising:
a first facility (21) and
a second facility (22)
wherein the second facility (22) is arranged above the first facility (21), and wherein the first current conductor (114) of the second facility (22) is arranged above the first current conductor (114) of the first facility (21), and the second current conductor (116) of the second facility (22) is arranged above the second current conductor (116) of the first facility (21).

42. Device (400) according to claim 41, wherein the device (400) is developed such that by making a first electric connection by means of a suitable first electric connecting system (160) between the first current conductor (114) of the second facility (22) and the first current conductor (114) of the first facility (21) as well as a second electric connection by means of a suitable second electric connecting system (160) between the second current conductor (116) of the second facility (22) and the second current conductor (116) of the first facility (21), a parallel connection of the facilities (21, 22) may be formed.

43. Device (400) according to claim 41, further comprising at least one facility wherein the facilities are arranged one upon the other such that the respective first current conductors of the facilities and the respective second current conductors of the facilities are arranged one upon the other, respectively.

44. Device according to claim 41, wherein the first current conductors (114) of the respective facilities (21, 22, . . . ) are connected to each other by means of an electric connecting system (160), and that the second current conductors (116) of the respective facilities (21, 22, . . . ) are connected to each other by means of an electric connecting system (160) such that a parallel connection of the facilities (21, 22, . . . ) is formed.

45. Device (400) according to claim 41, wherein the device (400) comprises two or more stacks of facilities (21, 22, . . . ) being arranged one upon the other.

46. Device (500) operating according to galvanic principles, comprising:
a first facility (21) and
a second facility (22) wherein the second facility (22) is arranged above the first facility (21), and wherein the first current conductor (114) of the second facility (22) is arranged above the second current conductor (116) of the first facility (21), and the second current conductor (116) of the second facility (22) is arranged above the first current conductor (114) of the first facility (21).

47. Device (500) according to claim 46, wherein the device (500) is developed such that by making an electric connection by means of a suitable electric connecting system (160) between the first current conductor (114) of the second facility (22) and the second current conductor (116) of the first facility (21), a serial connection of the facilities (21, 22) may be formed.

48. Device (500) according to claim 46, further comprising at least one facility wherein the facilities are arranged one upon the other such that the first current conductor of an adjoining facility, which is arranged above a respective facility, is arranged above a respective second current conductor of the respective facility.

49. Device (500) according to claim 46, wherein the first current conductor of an adjoining facility, which is arranged above a respective facility, is connected by means of an electric connecting system (160) to a respective second current conductor of the respective facility such that a serial connection of the facilities being arranged one upon the other is formed.

50. Device (400, 500) according to claim 46, wherein the device (400, 500) comprises two or several stacks of facilities (21, 22) being arranged one upon the other.

51. Device according to claim 40, wherein the stacks are arranged side by side in a linear, bi-linear or multi-linear arrangement.

52. Device (200, 300, 400, 500) according to claim 51, wherein at least two or more linear, bi-linear or multi-linear arrangements are arranged side by side and/or one upon the other.

53. Device (200, 300, 400, 500) according to claim 46, in the stacking, respectively in the arrangement of stacks side by side, between the respective facilities, which are arranged one upon the other, respectively side by side, one or several, in particular thin, preferably electrically isolating, preferably vibration-reducing, preferably flexible, foil or layer is arranged.

54. Device (200, 300, 400, 500) according to claim 46, by a receiving facility for thermal energy, which is coupled in heat flow communication to one or more heat conducting facilities (124) for receiving thermal energy, which is dissipated from the one or from the several heat conducting facilities (124).
